(19) United States
(12) Patent Application Publication
(10) Pub. No.: US 2019/0346035 A1
(43) Pub. Date: Nov. 14, 2019

(54) METHOD OF MANUFACTURING GEAR AND GEAR

(71) Applicant: CANON KABUSHIKI KAISHA, Tokyo (JP)

(72) Inventor: Gaku Iijima, Yokohama-shi (JP)

(21) Appl. No.: 16/389,228

(22) Filed: Apr. 19, 2019

(30) Foreign Application Priority Data
May 9, 2018 (JP) 2018-090875

(51) Int. Cl. F16H 55/17; B29C 45/16; F16H 57/00; G03G 15/00

(52) U.S. Cl. CPC F16H 55/17; B29C 45/1635; B29K 2059/00; G03G 15/757; F16H 57/0025

(57) ABSTRACT

A gear includes a center portion and a peripheral portion. The center portion includes a rotation support portion and an inner web. The peripheral portion includes an annular rim having teeth and an outer web, and made of a material different from a material of the center portion. One portion of the outer web is configured to hold one portion of the inner web. An outer surface of the one portion of the outer web is sloped such that a thickness of the outer web increases as the outer web extends from the rotation support portion toward the rim.

### BACKGROUND OF THE INVENTION

### Field of the Invention

The present invention relates to a method of manufacturing a gear and the gear, and in particular, relates to a method of manufacturing a composite gear in which a tooth portion and a rotation support portion are made of different materials, and the composite gear.

### Description of the Related Art

In recent years, resin gears are used as power transmission parts in a wide variety of mechanical products, such as office automation equipment including copying machines and printers, consumables including ink cartridges, and small precision devices including digital cameras and video cameras.

For the resin gears used as high-precision power transmission parts, specifications are provided, conforming to standards on accuracy of shape of gears. The standards are set in accordance with use and purpose, and include items such as tip circle size, meshing error (Japan Gear Manufacturers Association: JGMA 116-02), and grade of tooth trace (Japanese Industrial Standards: JIS B 1702). In particular, for resin gears of mechanical products required to have high precision, an allowable range in the standards on the accuracy of shape is often narrowed to improve quality.

In addition, recent color printers and color copying machines are increasingly demanded to reduce their noise and vibration, as well as to increase printing speed and quality. To satisfy theses demands, however, narrowing the allowable range in the accuracy of shape of gears is insufficient. Specifically, accuracy in dynamic operation of gears, such as accuracy in transmitting rotation (see Appendix 1 of JIS B 1702-3), is required to be increased.

In general, the accuracy of a helical gear in transmitting rotation is deteriorated due to the following factors: (1) insufficient accuracy of a tooth surface, (2) insufficient accuracy of a gear support portion, and (3) deformation of the gear caused when the gear is rotated.

The factor (1) is possibly caused when standards applied to the tooth surface are not suitable for use condition, or when the shape of the tooth surface is deteriorated because the resin was contracted when the gear was molded. The factor (2) is typically caused when the support shaft of the gear is eccentric or inclined from the rotation axis of the gear. The factor (3) is possibly caused when the gear does not have sufficient strength against the torque produced when the gear is rotated at a predetermined rotational speed in an actual mechanical product. The factors (1) and (2) can be controlled by setting specifications including items such as accuracy in tooth trace (HS B 1702) and coaxiality, and by using a gear which satisfies the specifications. However, unlike the factors (1) and (2) which can be controlled by the specifications provided for static conditions, the factor (3) which is caused in dynamic conditions of gears is difficult to control by setting the specifications.

FIG. 10A is a plan view of one example of conventional gears. FIG. 10B is a cross-sectional view of the gear, taken along a line A-A of FIG. 10A. A resin gear 170 includes an annular rim 172 in which helical teeth 171 are formed, a rotation support portion which is formed around a central axis 174 of the gear, and a web 179 which joins the rim 172 and the rotation support portion. The rotation support portion includes a cylindrical portion 183 having an inner surface 181 and an outer surface 182. The rotation support portion is supported by a corresponding mechanical product in accordance with the configuration of the mechanical product. For example, the rotation support portion may be supported by fitting a resin or metal shaft into a hole of the rotation support portion formed by the inner surface 181, or by providing a bearing on the outer surface 182.

Here, there will be described how the conventional gear is deformed when rotated. When the resin gear 170 is rotated, the occurrence of torque causes torsional moment in the rotation support portion. If the helical teeth 171 are formed, a torsion component of the teeth 171 produces force also in a thrust direction (i.e. direction in which the rotation axis extends). That is, a plurality of components of force occurs in the rotation support portion.

In the conventional resin gear, the whole of the gear is made of a resin material, such as polyacetal, which has good slidability and relatively-high mechanical strength. In recent years, however, the increase in functionality of mechanical products causes gears to receive higher force, and increases load on the rotation support portion. Thus, the resin gear, the whole of which is made of polyacetal alone, may be disadvantageously deformed.

For this reason, a composite gear is proposed. In the composite gear, the rotation support portion is made of a synthetic resin other than polyacetal and having high stiffness, and the teeth are made of a conventional resin such as polyacetal.

FIG. 11A is a plan view of one example of composite gears made of two types of material. FIG. 11B is a cross-sectional view of the gear, taken along a line B-B of FIG. 11A. FIG. 11C is an enlarged view of a portion C of FIG. 11B.

A composite gear 140 is constituted by a first member 150 and a second member 160. The first member 150 includes a rotation support portion formed around a central axis 151, and is made of a synthetic resin with high stiffness. The second member 160 includes a tooth portion 161 formed in the outer circumferential portion of the second member 160, and is made of a synthetic resin softer than that of the first member 150. The rotation support portion of the first member 150 includes a cylindrical portion 154 having an inner surface 152 and an outer surface 153. On an outer circumferential portion of the cylindrical portion 154 of the first member 150, an inner web 155 is formed. An outer edge portion of the inner web 155 is held by an outer web 162 of the second member 160. In other words, the second member 160 includes the outer web 162 which covers and holds an outer edge of the inner web 155 of the first member 150.

Since the first member 150 of the composite gear 140 is made of the high-stiffness material, the deformation of the composite gear 140, caused by the torsional moment and the thrust component of force produced when the composite gear 140 is rotated, can be suppressed. As a result, the problem caused by the above-described factor (3) can be reduced. In addition, since the second member is made of a conventional synthetic resin, the sliding performance required for the gear can be ensured.

Japanese Patent Application Publication No. H2-72259 discloses a technique to ensure the accuracy of a composite gear. In this technique, the composite gear is constituted by a primary molded component and a secondary molded component; and the primary molded component and the secondary molded component are made of different resin materials, and structured to engage with each other. In this structure, when the secondary molded component is contracted, firm joining force is produced between the primary molded component and the secondary molded component.

In addition, Japanese Patent Application Publication No. 2001-336608 discloses a technique to ensure the stiffness of a composite gear. In this technique, a tooth portion is first made of a material having a small modulus of elasticity and good slidability, and then a disk portion having a center axis of rotation is made of amorphous resin.

To manufacture such composite gears, one method can be used. In the method, a first member is first injection-molded by using a first mold, then the first member is removed from the first mold and inserted into a second mold, and a second member is secondarily molded on the first member. In this method, however, not only the two dedicated molds but also an intermediate process to remove the molded first member from the first mold and insert the molded first member into the second mold becomes necessary, reducing the production efficiency. Furthermore, since the first member is once removed from the first mold and inserted into the second mold, reproducibility in the center position of the axis of the first member will deteriorate, and coaxiality of the rotation support portion and the tooth portion will vary in molded products.

To solve this problem, in-mold assembly technique is proposed. The technique uses a rotary molding machine, a two-color molding machine, or a method such as a die slide injection (DSI) or die rotating injection (DRI). Here, an in-mold assembly technique using the DSI method will be described with reference to FIGS. 12A and 12B. FIGS. 12A and 12B are schematic cross-sectional views illustrating processes to form the composite gear of FIGS. 11A to 11C.

FIG. 12A is a schematic cross-sectional view illustrating a process to form the first member 150 by using a mold 105. FIG. 12A illustrates a state in which the high-stiffness material has been injected into a cavity located on the left side of the mold 105, through a gate located on the upper side in FIG. 12A, and in which the material is being cooled, while the pressure on the material is being kept constant. The cavity used to form the first member 150 is formed by a fixed mold and a moving mold. The fixed mold includes a slide piece 106, and is located at the upper left in FIG. 12A. The moving mold includes a moving piece 107 in which a piece 107a and a piece 107b are set, and is located on the lower side in FIG. 12A. The slide piece 106 is a piece to form the outer circumferential side surface and one portion of the bottom surface of the inner web 155. The piece 107a is a piece to form the inner surface 152 of the cylindrical portion 154 of the gear. The piece 107b is a piece to form the outer surface 153 of the cylindrical portion 154 of the gear and one portion of the bottom surface of the inner web 155.

After the formation of the first member 150, the slide piece 106 is retracted laterally, then the first member 150 and the moving piece 107 are moved downward in FIG. 12A, then the moving piece 107 is moved rightward in FIG. 12A to a position which allows the moving piece 107 to form the second member 160, and then the moving piece 107 is moved upward. With this operation, as illustrated in FIG. 12B, a cavity used to form the second member 160 is formed in a state where the first member 150 is inserted. A synthetic resin is then injected into the cavity used to form the second member 160, from a gate other than the gate used to form the first member 150; and the second member 160 including the tooth portion 161 is formed. In this method, after the formation of the first member 150, the tooth portion 161 can be successively formed without the rotation support portion being separated from the moving mold (moving piece 107). As a result, the accuracy in coaxiality of the rotation support portion and the tooth portion 161 with respect to the central axis 151 can be easily ensured.

Here, to ensure the stiffness of the composite gear, the first member and the second member are required to firmly join with each other. Thus, as illustrated in FIG. 11C, it is preferable that one portion of the inner web 155 of the first member 150 is covered by the outer web 162 of the second member 160 such that the one portion of the inner web 155 is sandwiched between an upper portion and a lower portion of the outer web 162, and that a contact area between the inner web 155 and the outer web 162 is large. For this reason, when the first member 150 is formed, the slide piece 106 is positioned by sliding a portion of the slide piece 106 (disposed in the fixed mold located on the upper side in FIG. 12A) closer to the rotation support portion, into the space between the bottom surface of the inner web 155 and the moving mold located on the lower side in FIG. 12A. Thus, when the cavity illustrated in FIG. 12B and used to form the second member 160 is formed, a cavity space beneath one portion of the bottom surface of the inner web 155 is ensured to inject the resin into the cavity space, so that the bottom surface of the inner web 155 and the outer web 162 can be joined with each other. In this manner, the composite gear can be formed in a state where the edge portion of the inner web 155 is joined with and sandwiched between the upper portion and the lower portion of the outer web 162 of the second member 160, as illustrated in FIG. 11C.

However, the conventional in-mold assembly method, as described with reference to FIGS. 12A and 12B, has a problem in which the mold is easily abraded.

In the in-mold assembly method involving the rotary molding machine or the DRI, it is common that a moving piece is first set in a moving mold, then a first member is molded, and then the first member and the moving piece are moved to a position which allows a second member to be molded. Here, if the first member is left on the fixed mold when the mold is opened by moving the moving piece 107 downward, the method cannot proceed to a process to mold the second member.

Specifically, the first member 150 will be retained by and left on the fixed mold when the mold 105 is opened by moving the moving piece 107 downward, unless the slide piece 106 of the mold 105 of FIG. 12A, which is disposed in the mold, is retracted in advance. FIG. 13 illustrates the mold 105 of FIG. 12A in a state where the first member 150 is left on the fixed mold when the mold 105 is opened with the slide piece 106 being positioned at an un-retracted position (i.e. position which allows the first member to be formed).

As can be seen from this, when the mold 105 is opened by moving the moving piece 107 downward, the slide piece 106 is required to be retracted toward both sides in the lateral direction, in advance, to move the first member 150 together with the moving piece 107. FIG. 14A is a cross-sectional view illustrating a state in which the slide piece 106 is retracted in the lateral direction before the mold 105 is opened by moving the moving piece 107 downward. FIG. 14B is an enlarged view of a portion D of the FIG. 14A.

As can be seen from FIGS. 14A and 14B, when the slide piece 106 is moved laterally in a state where the mold 105 is closed, the slide piece 106 slides on the moving piece 107 while the parting surface of the moving piece 107 (piece 107b) of the moving mold and the slide piece 106 of the fixed mold are in contact with each other. As a result, abrasion and damage are easily caused. Thus, since the pieces of the mold are significantly abraded, it has been difficult to mass-produce high-precision composite gears for a long time. As an alternative, the slide piece 106 of the fixed mold may not be used, and the space between the inner web 155 and the moving piece 107 may be formed by core-backing a piece of the moving mold, to cover the first member 150 with the second member 160. However, if the piece is core-backed, the coaxiality of the rotation support portion will change, deteriorating the accuracy of shape of the composite gear.

Thus, in the conventional method of forming a composite gear, it has been difficult to ensure the durability of the mold, firmly join the first member and the second member of the composite gear, and ensure the accuracy in coaxiality of the rotation support portion and the tooth portion.

### SUMMARY OF THE INVENTION

According to a first aspect of the present invention, a method of manufacturing a gear by using a fixed mold and a moving mold which are configured to form a cavity used to injection-mold a center portion of the gear and a cavity used to injection-mold a peripheral portion of the gear, the fixed mold including a plurality of slide pieces configured to form one portion of an inner web of the gear, the moving mold including a forming surface configured to form one portion of an outer web of the gear, the method includes causing a bottom surface of each of the plurality of slide pieces and the forming surface to abut against each other to form the cavity used to form the center portion, wherein the bottom surface of each slide piece is sloped with respect to a slide direction of the slide piece, and the forming surface is sloped with respect to the slide direction, injecting a first material from a first gate to the cavity to form the center portion, sliding each of the plurality of slide pieces along the slide direction of each of the plurality of slide pieces to separate the bottom surface of each of the plurality of slide pieces from the forming surface, moving the moving mold, holding the center portion, to a position where the moving mold forms the cavity used to form the peripheral portion with the fixed mold, and injecting a second material from a second gate to the cavity to form the peripheral portion, the second material being different from the first material.

According to a second aspect of the present invention, a gear includes a center portion including a rotation support portion and an inner web, and a peripheral portion including an annular rim having teeth and an outer web, and made of a material different from a material of the center portion. One portion of the outer web is configured to hold one portion of the inner web. An outer surface of the one portion of the outer web is sloped such that a thickness of the outer web increases as the outer web extends from the rotation support portion toward the rim.

Further features of the present invention will become apparent from the following description of exemplary embodiments with reference to the attached drawings.

### BRIEF DESCRIPTION OF THE DRAWINGS

FIG. 1A is a plan view of a gear of a first embodiment.

FIG. 1B is a cross-sectional view of the gear of the first embodiment.

FIG. 1C is an enlarged view of one portion of FIG. 1B.

FIG. 2 is a perspective view of the gear of the first embodiment.

FIG. 3 is a cross-sectional view illustrating a state in which a first member of the gear of the first embodiment is formed.

FIG. 4A is a cross-sectional view illustrating a state in which a mold starts to open after the first member of the gear of the first embodiment is formed.

FIG. 4B is an enlarged view of one portion of FIG. 4A.

FIG. 4C is a cross-sectional view illustrating a state in which a moving piece of a moving mold is moved downward while holding the first member.

FIG. 5 is a cross-sectional view illustrating a state in which a second member of the gear of the first embodiment is formed.

FIG. 6A is a plan view of a gear of a second embodiment.

FIG. 6B is a cross-sectional view of the gear of the second embodiment.

FIG. 6C is an enlarged view of one portion of FIG. 6B.

FIG. 7 is a perspective view of the gear of the second embodiment.

FIG. 8A is a plan view of a gear of a third embodiment.

FIG. 8B is a cross-sectional view of the gear of the third embodiment.

FIG. 8C is an enlarged view of one portion of FIG. 8B.

FIG. 9A is a plan view of a gear of a fourth embodiment.

FIG. 9B is a cross-sectional view of the gear of the fourth embodiment.

FIG. 9C is an enlarged view of one portion of FIG. 9B.

FIG. 10A is a plan view of one example of conventional gears.

FIG. 10B is a cross-sectional view of the one example of conventional gears.

FIG. 11A is a plan view of one example of conventional composite gears.

FIG. 11B is a cross-sectional view of the one example of conventional composite gears.

FIG. 11C is an enlarged view of one portion of FIG. 11B.

FIG. 12A illustrates a process to form a first member of a conventional composite gear.

FIG. 12B illustrates a process to form a second member of the conventional composite gear.

FIG. 13 illustrates a state in which the first member is left on a fixed mold in a conventional mold.

FIG. 14A is a cross-sectional view illustrating a state in which a slide piece is retracted in the conventional mold.

FIG. 14B is an enlarged view of one portion of FIG. 14A.

FIG. 15 is a cross-sectional view of an image forming apparatus including a gear of any one of the first to the fourth embodiments.

FIG. 16 is an enlarged view of one portion of the image forming apparatus including a gear of any one of the first to the fourth embodiments.

### DESCRIPTION OF THE EMBODIMENTS

### First Embodiment

Hereinafter, a gear of a first embodiment of the present invention, a method of manufacturing the gear, and a mold used to manufacture the gear will be described with reference to the accompanying drawings.

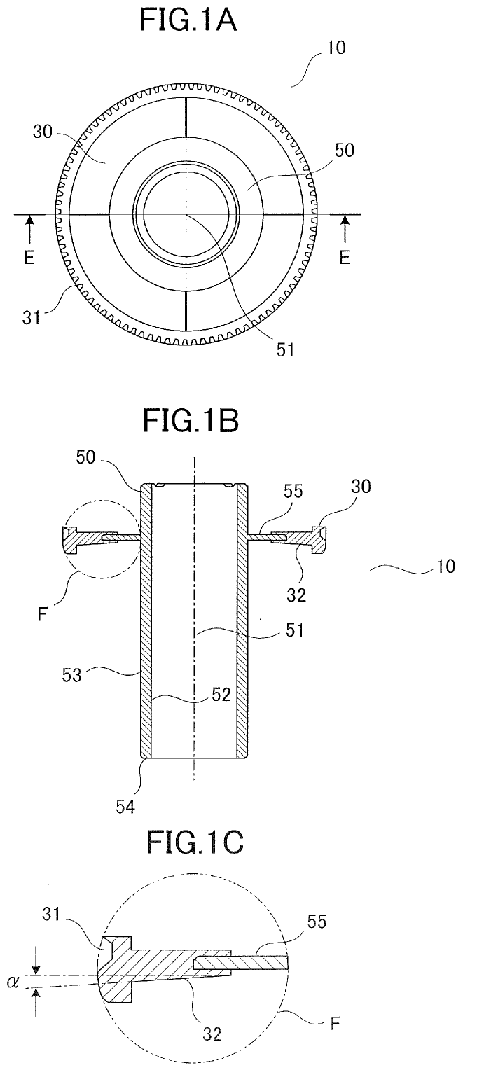

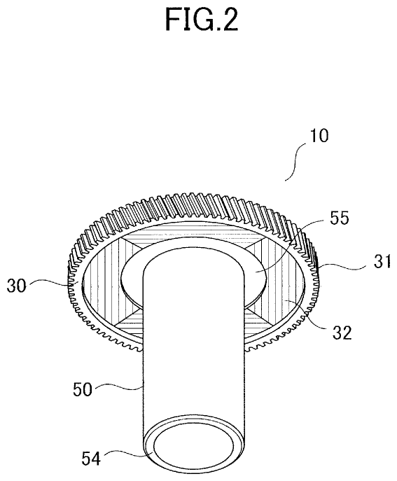

FIG. 1A is a plan view of the gear of the first embodiment. FIG. 1B is a cross-sectional view taken along a line E-E of FIG. 1A. FIG. 1C is an enlarged view of a portion F of FIG. 1B. FIG. 2 is a perspective view of the gear of the present embodiment.

A composite gear 10 includes an annular rim in which a tooth portion 31 is formed, a rotation support portion which is formed around a central axis 51, an inner web 55, and an outer web 32. The rim and the rotation support portion are joined with each other via the inner web 55 and the outer web 32. The rotation support portion includes a cylindrical portion 54 having an inner surface 52 and an outer surface 53. The shape of the rotation support portion and the method of supporting the rotation support portion may be selected as appropriate in accordance with the configuration of a corresponding mechanical product. For example, the rotation support portion may be supported by fitting a resin or metal shaft into a hole of the rotation support portion formed by the inner surface 52, or by providing a bearing on the outer surface 53.

The composite gear 10 includes a first member 50 which is a center portion, and a second member 30 which is a peripheral portion. The first member 50, which is a center portion, is made of a material having a main component of a synthetic resin, and includes the rotation support portion and the inner web 55. The second member 30, which is a peripheral portion, is made of a material which has a main component of a synthetic resin and which is softer than that of the first member; and includes the annular rim in which the tooth portion 31 is formed and the outer web 32.

The first member 50 is made of the material harder than that of the second member 30. That is, Young's modulus of the material of the first member is larger than that of the second member 30. The selection of the material is made in consideration of stress which is applied to each part of the gear when the gear is rotated to transmit power. Specifically, the material of the first member 50 has a larger Young's modulus, because the first member 50, which includes the rotation support portion and the inner web 55, receives higher stress than that of the second member 30 when the gear is rotated by the driving force applied to the gear. In contrast, the material of the second member 30 is softer than that of the first member 50, because the second member 30 receives lower stress than that of the first member 50 and needs to have lower sliding resistance and noise. Here, the bending modulus of elasticity measured under IS0178 may be estimated. In this case, the bending modulus of elasticity of the material of the first member 50 may be equal to or larger than 5 [GPa] and equal to or smaller than 15 [GPa], and the bending modulus of elasticity of the material of the second member 30 may be equal to or larger than 1 [GPa] and smaller than 5 [GPa].

For example, the first member 50 may be made of material having a main component of a resin material, such as polyacetal, polybutylene terephthalate, polyphenylene sulfide, polyamide, or nylon. The second member 30 may be made of a material having a smaller bending modulus of elasticity than that of the first member 50 and a main component of resin material, such as polyacetal.

In the present embodiment, an outer circumferential portion of the inner web 55 of the composite gear is joined with an inner circumferential portion of the outer web 32. As illustrated in FIG. 1C, the outer circumferential portion of the inner web 55 is joined with the inner circumferential portion of the outer web 32 such that an outer edge portion of the inner web 55 is covered with and sandwiched between an upper portion and a lower portion of the outer web 32. Thus, the inner web 55 and the outer web 32 are firmly joined with each other. The bottom surface of the outer web 32 is sloped at an angle of a with respect to a direction in which the outer web 32 extends from the inner web 55 toward the tooth portion 31 and which is orthogonal to the rotation axis. With this slope, the thickness of the outer web 32 increases as the outer web 32 extends from the inner web 55 toward the tooth portion 31.

In the perspective view of FIG. 2, lines of the bottom surface of the outer web 32 are contour lines illustrated for convenience of description. As can be seen from FIG. 2, in the present embodiment, the thickness of the outer web 32 increases along four directions as the outer web 32 extends from the rotation support portion toward the tooth portion 31. That is, the thickness of the outer web 32 increases along four planes which are sloped toward different directions. Thus, since the thickness of the outer web 32 increases as the outer web 32 extends toward the tooth portion 31, the slide piece of the mold can be easily moved in a later-described manufacturing process. Consequently, the durability of the mold and the efficiency in mass production can be increased.

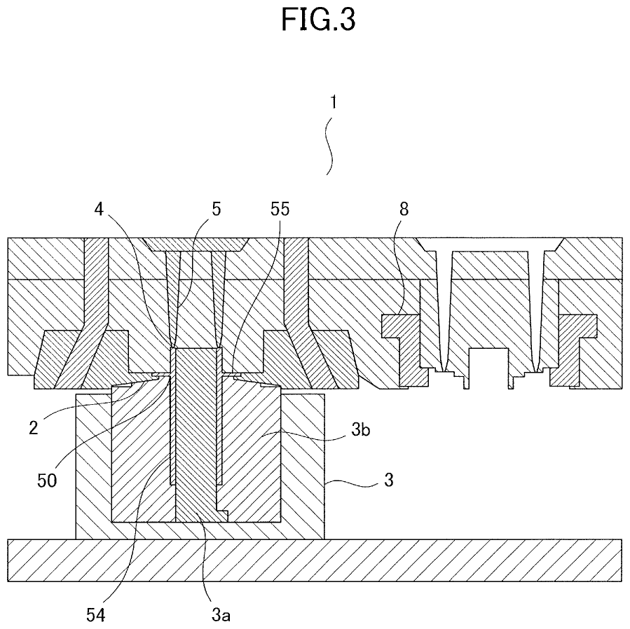

Next, with reference to FIGS. 3 to 5, a method of manufacturing the composite gear of the first embodiment, and a mold used to manufacture the composite gear will be described.

A mold 1 of the present embodiment is an injection molding mold used to form the composite gear 10 by injection-molding the first member 50 and the second member 30 by using the DSI method. The mold 1 includes a fixed mold located on the upper side in FIG. 3, and a moving mold located on the lower side in FIG. 3. In other words, the mold 1 includes the fixed mold and the moving mold which can form a cavity used to injection-mold the center portion of the gear and a cavity used to injection-mold the peripheral portion of the gear.

A slide piece 2 of the fixed mold is a piece to form the outer circumferential side surface and one portion of the bottom surface of the inner web 55. When the mold 1 is closed, the slide piece 2 is positioned by sliding the slide piece 2 into the space beneath the lower surface of the inner web 55 so that the top surface of a tip portion of the slide piece 2 forms the bottom surface of an outer edge portion of the inner web 55.

A moving piece 3 of the moving mold has a piece 3a and a piece 3b. The piece 3a is used to form the inner surface 52 of the cylindrical portion 54 of the gear, and the piece 3b is used to form the outer surface 53 of the cylindrical portion 54 of the gear and one portion of the bottom surface of the inner web 55. After the first member 50 is formed, the moving piece 3 which is holding the first member 50 can be moved, in the mold 1, to a position which allows the second member 30 to be formed. The piece 3b of the moving mold has a forming surface which forms one portion of the outer web 32 when the second member 30 is formed.

FIG. 3 is a schematic cross-sectional view illustrating a state in which the moving piece 3 is positioned at a position which allows the first member 50 to be formed in the mold 1, and in which the first member 50 is being formed. In the mold 1, the slide piece 2 is disposed in the fixed mold located on the upper side in FIG. 3, at a position which allows the first member 50 to be formed and which is located on the left side in FIG. 3. In addition, a gate 4 is disposed in the fixed mold, as a first gate. From the gate 4, melted resin, which is a first material supplied via a runner 5, is injected into the cavity used to form the first member 50.

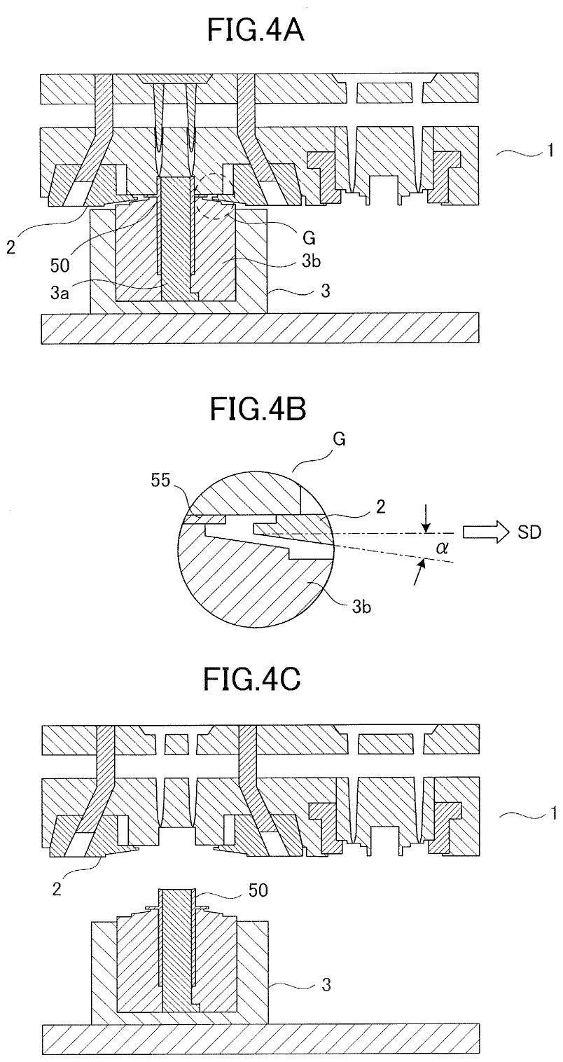

FIG. 4A is a schematic cross-sectional view illustrating a state in which the mold 1 starts to open after the first member 50 is formed of the first material that is a relatively-harder resin material. FIG. 4B is an enlarged view of a portion G of FIG. 4A.

When the mold 1 starts to open, the slide piece 2 is retracted laterally, and separated from the inner web 55 of the first member 50. Here, the direction in which the slide piece 2 slides is referred to as a slide-piece moving direction SD, for convenience. The slide-piece moving direction SD is normally orthogonal to the central axis 51 of the rotation support portion of the composite gear.

In the present embodiment, the parting surface of the slide piece 2 and the parting surface of the moving piece 3 (piece 3b), that is, the surface of the slide piece 2 and the surface of the moving piece 3 which contact each other when the mold 1 is closed are not parallel to the slide-piece moving direction SD, in which the slide piece 2 is retracted; and is sloped at an angle of α. That is, the bottom surface of the slide piece 2 and the top surface of the moving piece 3 (piece 3b) contact each other in a plane not parallel to the slide-piece moving direction SD but sloped at the angle α.

If the abutment surfaces of the slide piece 2 and the moving piece 3 (piece 3b) are parallel to the slide-piece moving direction SD as in a conventional mold, the bottom surface of the slide piece 2 will continue to contact the top surface of the moving piece 3 while the slide piece 2 is moved in a state where the mold 1 is closed. Thus, the pieces will be significantly abraded, deteriorating the durability of the mold. In contrast, in the present embodiment, the slide piece 2 is sloped at the angle α. Thus, when the slide piece 2 is moved laterally and retracted in a state where the mold 1 is closed in the vertical direction, the bottom surface of the slide piece 2 and the top surface of the moving piece 3 (piece 3b) are immediately separated from each other, and the slide piece 2 does not continue to slide on the moving piece 3 (piece 3b). As a result, the abrasion of the pieces can be significantly reduced, and thus the durability of the mold and the efficiency in mass production of the composite gear can be improved.

Here, the angle α is preferably equal to or larger than 0.5 degrees and equal to or smaller than 5.0 degrees. Theoretically, if the bottom surface of the slide piece 2 and the top surface of the moving piece 3 are sloped even a little with respect to the slide-piece moving direction SD, the slide piece 2 can be prevented from sliding on the moving piece 3. However, if the angle α is small, the bottom surface of the slide piece 2 and the top surface of the moving piece 3 are required to have high accuracy in flatness, which will increase production cost of the pieces. For this reason, the angle α is preferably equal to or larger than 0.5 degrees. On the other hand, if the angle α is too large, the thickness of the outer web 32 in the vicinity of the tooth portion 31 may become unnecessarily large (the thickness of the outer web 32 of the gear increases as the outer web 32 extends toward the tooth portion 31). If the thickness of a portion of the outer web 32 in the vicinity of the tooth portion 31 becomes too large, the volume of a portion (in the vicinity of the tooth portion) of the cavity used to form the second member 30 becomes large. Thus, when the melted resin is injected into the cavity, heat will be hardly dissipated from the portion of the cavity. As a result, when the resin is cooled, a sink mark (i.e. deformation caused by contraction) easily occurs, possibly deteriorating the accuracy of shape of the tooth portion 31. For this reason, the angle α is preferably equal to or smaller than 5.0 degrees.

Then, as illustrated in FIG. 4C, the moving piece 3 of the moving mold moves down while holding the first member 50, and the mold 1 is temporarily opened.

The moving piece 3 then moves rightward in FIG. 4C, while holding the first member 50, to a position which is directly under the fixed mold used to form the second member 30. Then the moving piece 3 moves upward while holding the first member 50, and closes the mold 1. With this operation, the cavity to form the second member 30 is formed.

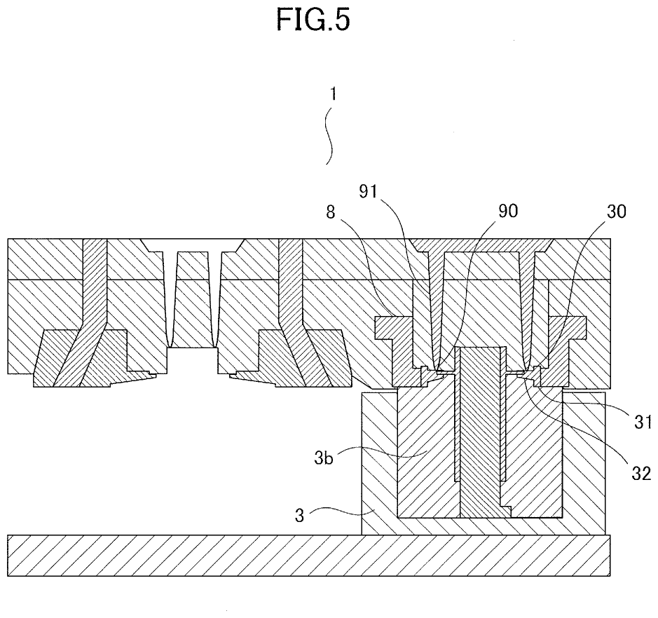

FIG. 5 is a schematic cross-sectional view illustrating a state in which the moving piece 3 has moved, in the mold 1, to a position which allows the second member 30 to be formed, and in which the second member 30 is being formed. In the fixed mold, a gate 90 is disposed as a second gate. From the gate 90, the melted resin, which is a second material supplied via a runner 91, is injected into the cavity used to form the second member 30. In addition, a gear piece 8 used to form the tooth portion 31 is disposed in the fixed mold, at a position which allows the second member 30 to be formed. Since the top surface of the moving piece 3 (piece 3b) is sloped at the angle α as illustrated in FIG. 4B, the outer web 32 of the second member 30 is also sloped at the angle α so that the thickness of the outer web 32 increases as the outer web 32 extends toward the tooth portion 31.

In the present embodiment, the slide piece 2 of the mold 1 is constituted by four pieces such that, when viewed from above of the mold 1, the slide-piece moving direction SD is constituted by four directions, each having an angle of 90 degrees with respect to an adjacent direction. In addition, each slope of the outer web 32 is not a curved surface but a flat surface having the angle α. Since the forming surface of the moving piece 3 (piece 3b) is formed in accordance with the shape of the slide piece 2, the outer web 32 of the composite gear of the present embodiment is formed such that the thickness of the outer web 32 increases along the four directions, as illustrated in FIG. 2, as the outer web 32 extends from the rotation support portion toward the tooth portion 31.

In the above-described composite gear of the present embodiment, since the second member firmly holds and joins with the first member, and the first member is made of the high-stiffness material, the deformation of the gear, caused by the torsional moment and the thrust component of force when the gear is rotated, can be suppressed. In manufacturing the gear, since the second member is formed without the first member being separated from the moving mold, the accuracy in coaxiality of the rotation support portion and the tooth portion can be increased. In addition, since the bottom surface of the slide piece (used to form the first member) of the fixed mold, and the top surface of the moving piece of the moving mold are sloped at the angle α with respect to the slide-piece moving direction, the abrasion of the mold can be reduced, which can improve the efficiency in mass production. Thus, the method of the present embodiment for manufacturing the composite gear, and the injection molding mold used for the method can ensure the durability of the mold, firmly join the first member and the second member of the composite gear, and ensure the accuracy in coaxiality of the rotation support portion and the tooth portion.

### Second Embodiment

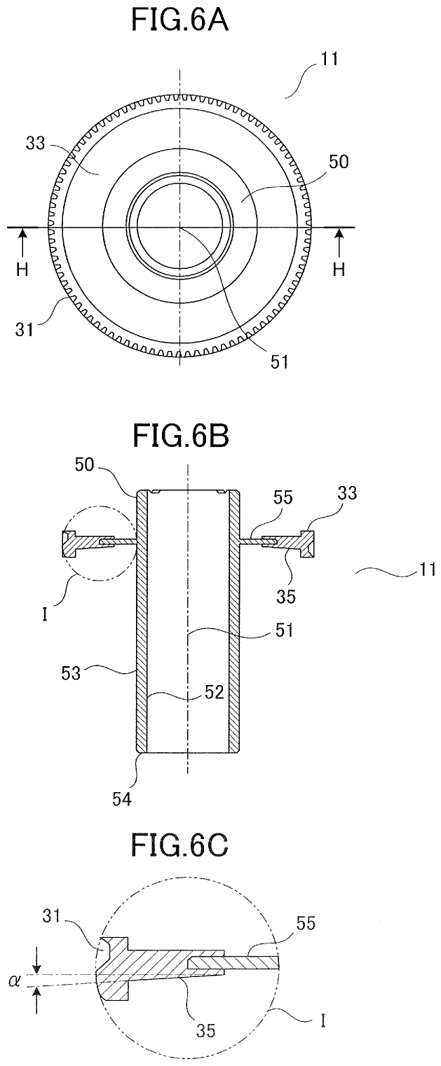

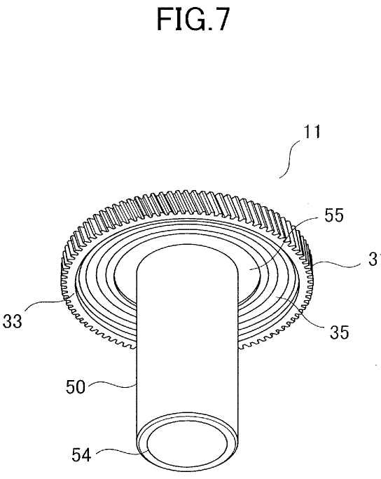

Next, a composite gear 11 of a second embodiment will be described with reference to FIGS. 6A to 6C and FIG. 7.

FIG. 6A is a plan view of the composite gear of the second embodiment. FIG. 6B is a cross-sectional view taken along a line H-H of FIG. 6A. FIG. 6C is an enlarged view of a portion I of FIG. 6B. FIG. 7 is a perspective view of the composite gear 11 of the second embodiment. Here, a component identical to that of the composite gear of the first embodiment is given an identical symbol, and duplicated description thereof will be omitted.

The rotation support portion and the inner web 55 of the first member 50 of the composite gear 11 of the second embodiment are the same as those of the composite gear 10 of the first embodiment. However, the shape of the bottom surface of the outer web 35 of the second member 33 of the second embodiment is different from that of the outer web 32 of the second member 30 of the composite gear 10 of the first embodiment.

In the perspective view of FIG. 7, a plurality of concentric lines of the bottom surface of the outer web 35 are contour lines illustrated for convenience of description. As can be seen from FIG. 7, in the present embodiment, the thickness of the outer web 35 increases evenly in all directions as the outer web 35 extends from the inner web 55 toward the tooth portion 31. Specifically, the bottom surface of the outer web 35 is sloped like a rotationally symmetric mortar.

In the first embodiment, the thickness of the outer web 32 increases toward the four directions along planes of a quadrangular pyramid as the outer web 32 extends from the rotation support portion toward the tooth portion. In the second embodiment, however, the thickness of the outer web 35 increases radially along the surface of a cone or a mortar. The shape of the forming surface of the moving piece 3 (piece 3b) of the second embodiment is formed in accordance with the shape of the bottom surface of the outer web 35. In the first embodiment, the thickness of the outer web 32 changes along the circumferential direction. In the second embodiment, however, the thickness of the outer web 35 does not change in the circumferential direction. Thus, the resin of the outer web 35 does not unevenly contract in the manufacture of the gear, and thus the accuracy of shape of the tooth portion hardly changes in the circumferential direction. Consequently, the gear with high accuracy can be formed. In addition, the rotationally symmetric outer web 35 of the present embodiment is well-balanced when the gear is rotated, and hardly causes turbulence of the air. Consequently, the gear with quietness can be formed.

The gear of the present embodiment can also be made by using the same manufacturing method as that of the first embodiment.

Also in the gear of the present embodiment, since the thickness of the outer web increases as the outer web extends toward the tooth portion, the abrasion, caused when the slide piece slides on the moving piece in the mold in the manufacturing process, can be suppressed. Consequently, the durability of the mold and the efficiency in mass production can be increased.

### Third Embodiment

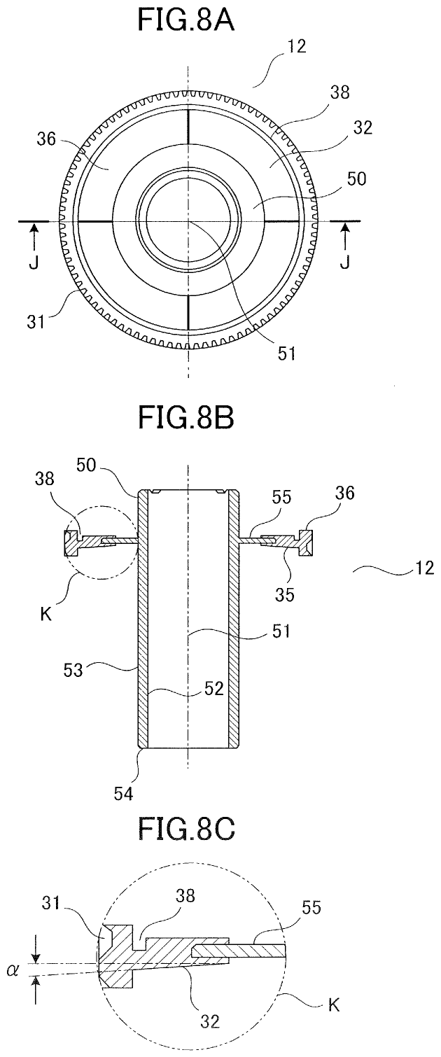

Next, a composite gear 12 of a third embodiment will be described with reference to FIGS. 8A to 8C.

FIG. 8A is a plan view of the composite gear of the third embodiment. FIG. 8B is a cross-sectional view taken along a line J-J of FIG. 8A. FIG. 8C is an enlarged view of a portion K of FIG. 8B. Here, a component identical to that of the composite gear of the first embodiment is given an identical symbol, and duplicated description thereof will be omitted.

The rotation support portion and the inner web 55 of the first member 50 of the composite gear 12 of the third embodiment are the same as those of the composite gear 10 of the first embodiment. However, a second member 36 of the third embodiment differs from the second member 30 of the first embodiment in that an annular groove 38 is formed in the outer web 32 in the vicinity of the tooth portion 31 so that the thickness of the outer web 32 becomes constant in the circumference of the outer web 32. Preferably, the groove 38 is formed along a circle formed around the central axis 51.

In the first and the second embodiments, since the bottom surface of the outer web 32 is sloped at the angle α, the thickness of the outer web 32 increases as the outer web extends toward the tooth portion. If the thickness of a portion of the outer web 32 in the vicinity of the tooth portion 31 is too large, heat is hardly dissipated from the portion in the manufacture of the gear, possibly affecting the shape of the tooth portion 31 when the outer web 32 is cooled. That is, if the thickness of the portion of the outer web 32 in the vicinity of the tooth portion 31 is too large, the deformation of the outer web 32 called sink mark may deteriorate the accuracy of shape of the tooth portion 31.

In the present embodiment, even if the thickness of the outer web 32 would increase as the outer web 32 extends toward the tooth portion 31, the groove 38, formed in a position where the tooth portion 31 and the outer web 32 meet with each other, can suppress the contraction of a thick portion of the outer web 32 from affecting the shape of the tooth portion 31.

Here, in the first embodiment in which the thickness of the outer web changes in the circumferential direction, the outer web easily contracts unevenly in all directions, possibly causing the accuracy of shape of the tooth portion to be uneven in the circumferential direction.

In the present embodiment, however, the groove 38 is formed in the outer web 32 in the vicinity of the tooth portion 31 so that the thickness of the outer web 32 becomes constant in the circumference of the outer web 32. As a result, even when the outer web 32 contracts unevenly in all directions in the manufacture of the gear, the present embodiment can suppress the contraction from affecting the accuracy of shape of the tooth portion 31.

The gear of the present embodiment can also be made by using the same manufacturing method as that of the first embodiment. Also in the gear of the present embodiment, since the thickness of the outer web increases as the outer web extends toward the tooth portion, the abrasion, caused when the slide piece slides on the moving piece in the mold in the manufacturing process, can be suppressed. Consequently, the durability of the mold and the efficiency in mass production can be increased.

### Fourth Embodiment

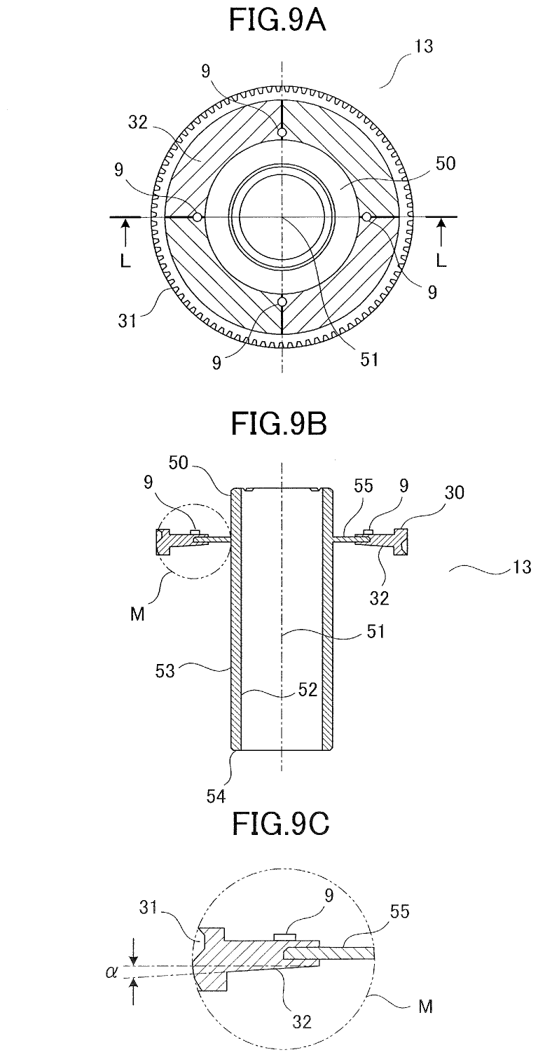

Next, a composite gear of a fourth embodiment will be described with reference to FIGS. 9A to 9C.

FIG. 9A is a plan view of the composite gear of the fourth embodiment. FIG. 9B is a cross-sectional view taken along a line L-L of FIG. 9A. FIG. 9C is an enlarged view of a portion M of FIG. 9B. Here, a component identical to that of the composite gear of the first embodiment is given an identical symbol, and duplicated description thereof will be omitted. In FIG. 9A, oblique lines given to the outer web 32 and extending in four directions are contour lines illustrated for convenience of description.

A composite gear 13 of the fourth embodiment is substantially the same as the composite gear of the first embodiment, but is different from the first embodiment in that the position of the gate, used to inject the resin into the cavity in the formation of the second member, is changed. That is, the gate is positioned at or near a position where the outer web 32 will have its minimum thickness, to inject the resin into the cavity to form the outer web 32. In other words, the gate is positioned at or near a position where the outer web 32 will hold the inner web, to inject the resin into the cavity. The composite gear of the present embodiment has a gate mark formed on the outer web 32, at a position where the outer web 32 has a small thickness.

The gate for the second member is formed to inject the resin into the cavity used to form the second member. In the present embodiment, the gate is formed within an area corresponding to a portion of the outer web 32 whose thickness is less than 50% of the maximum thickness of the outer web 32. Specifically, in FIGS. 9A to 9C, the resin is injected from a position at which a gate mark 9 is formed, to form the composite gear 13.

In the present embodiment, since the resin is injected from the gate positioned at or near a position where the outer web 32 holds the outer edge of the inner web 55, a cavity space used to form the holding portion of the outer web 32 can be reliably filled with the resin. Consequently, the composite gear in which the joining strength between the inner web 55 and the outer web 32 is ensured can be manufactured at a high yield.

The gear of the present embodiment can also be made by using the same manufacturing method as that of the first embodiment. Also in the gear of the present embodiment, since the thickness of the outer web increases as the outer web extends toward the tooth portion, the abrasion, caused when the slide piece slides on the moving piece in the mold in the manufacturing process, can be suppressed. Consequently, the durability of the mold and the efficiency in mass production can be increased.

### Modifications

The present invention, however, is not limited to the first to the fourth embodiments, and the embodiments may be appropriately modified or combined.

For example, the rotation support portion of the gear may not be cylindrical, and may be shaped like a right prism or a column.

The first member including the rotation support portion may be formed by metal-injecting a magnesium alloy by using Thixomolding method. In this case, the second member including the tooth portion may be formed by injection-molding a resin material which is softer than the magnesium alloy.

In the first embodiment, the slide piece 2 of the mold 1 is constituted by four pieces such that, when viewed from above of the mold 1, the slide-piece moving direction is constituted by four directions, each having an angle of 90 degrees with respect to an adjacent direction. However, the configuration of the slide piece 2 is not limited to the above-described configuration. For example, the slide piece 2 may be constituted by six pieces such that the slide-piece moving direction is constituted by six directions, each having an angle of 60 degrees with respect to an adjacent direction. Thus, the number of the pieces and directions in which the pieces move forward and backward may be changed as appropriate. In addition, the bottom surface of the slide piece of the fixed mold and the top surface of the moving piece of the moving mold, that is, the parting surfaces may be flat or curved surfaces as long as the parting surfaces are sloped with respect to the slide-piece moving direction. Thus, the outer surface of the outer web of the composite gear may be flat or curved as long as the thickness of the outer web increases as the outer web extends toward the tooth portion. Alternatively, the outer surface of the outer web may be a surface in which a flat surface and a curved surface are combined.

### Application Example of Gear

Next, there will be described an example in which a gear of the present invention is applied to a driving mechanism of a laser beam printer.

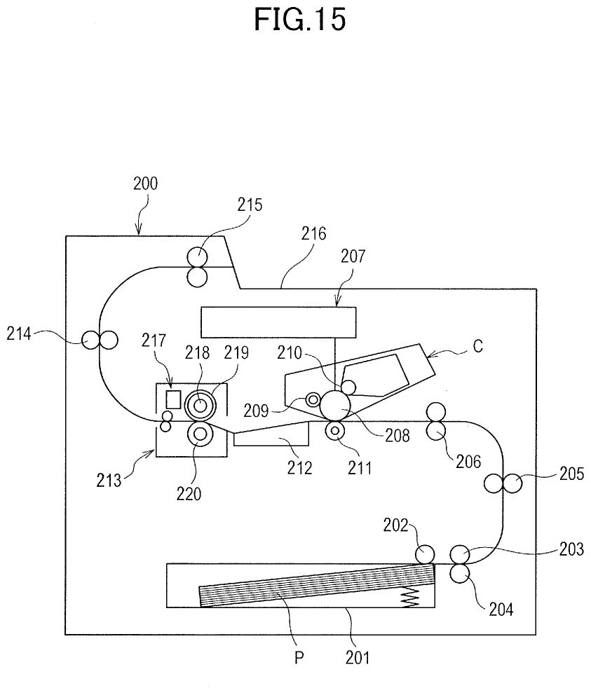

FIG. 15 is a cross-sectional view illustrating a schematic configuration of a laser beam printer 200, which is one example of image forming apparatuses. The laser beam printer 200 includes a deck 201 that stores a recording sheet P, which is a recording material; and a pickup roller 202 that sends the recording sheet P from the deck 201.

The laser beam printer 200 further includes a feed roller 203 and a retard roller 204. The feed roller 203 conveys the recording sheet P sent by the pickup roller 202. The retard roller 204 forms a pair, together with the feed roller; and prevents multi-feeding of the recording sheet P. On the downstream side in a conveyance direction in which the feed roller 203 conveys the recording sheet P, a conveyance roller 205 and a registration roller pair 206 are disposed.

The conveyance roller 205 conveys the recording sheet P downstream from the feed roller 203. The registration roller pair 206 conveys the recording sheet P in synchronization with an image forming operation. On the downstream side of the registration roller pair 206, a process cartridge C is detachably attached to an apparatus body of the laser beam printer 200. The process cartridge C constitutes an image forming unit that forms a toner image on a photosensitive drum 208 in accordance with a laser beam emitted from a later-described laser scanner 207.

The process cartridge C includes the rotatable photosensitive drum 208, a charging roller 209, a development unit 210, and a cleaning unit (not illustrated). The charging roller 209, the development unit 210, and the cleaning unit are disposed around the photosensitive drum 208. When an image is formed, the process cartridge C causes the charging roller 209 to uniformly charge the surface of the photosensitive drum 208. The surface of the photosensitive drum 208 is then selectively exposed by the laser scanner 207 disposed in the apparatus body of the laser beam printer 200. With this operation, a latent image (electrostatic latent image) is formed on the photosensitive drum 208, and the latent image is developed into a visible image by the development unit 210 by using toner. The toner image is transferred onto the recording sheet P having been conveyed to the photosensitive drum 208, by applying a transfer bias voltage to a transfer roller 211.

On the downstream side of the transfer roller 211, a conveyance guide 212 and a fixing apparatus 213 are disposed. The fixing apparatus 213 heat-fixes the toner image transferred on the recording sheet P. The fixing apparatus 213 includes a sheet separation apparatus.

Then the recording sheet P is sent to a discharging roller 215 by a conveyance roller pair 214, and discharged by the discharging roller 215 onto a discharging tray 216 disposed on a top surface of the apparatus body. With this operation, a series of processes is completed.

Here, the photosensitive drum 208 and a driving mechanism of the process cartridge C, which functions (rotates) with the photosensitive drum 208 to charge and expose the photosensitive drum 208, are required to have higher accuracy of rotation as the quality of image has been improved in recent years. However, such a driving system, which typically includes a brushless motor and a gear driving mechanism, may deteriorate the quality of image because the vibration of the driving motor and gears engaged with each other in a gear driving portion affects the photosensitive drum 208 and other components. Thus, a gear of the present invention may be applied to the driving system of the process cartridge C to reduce the vibration.

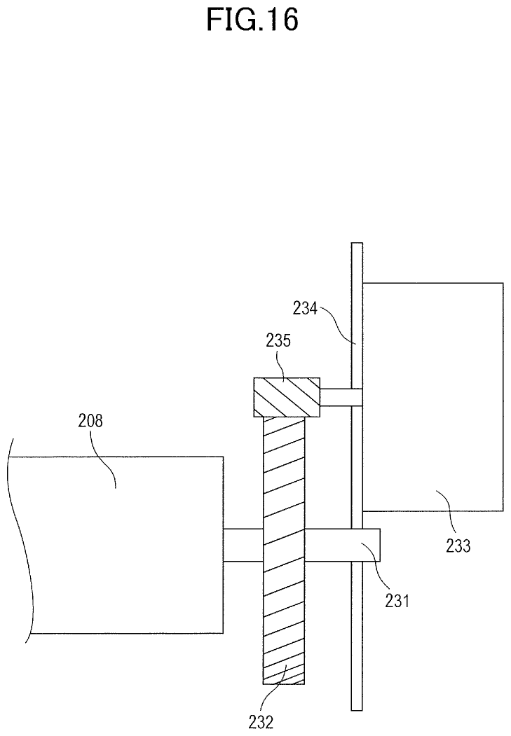

FIG. 16 is a schematic diagram in which a gear of the present invention is applied to a drum driving portion of the laser beam printer 200.

FIG. 16 illustrates the photosensitive drum 208, a drum shaft 231 which supports the photosensitive drum 208 so that the photosensitive drum 208 can rotate, and a helical gear 232 attached to the drum shaft 231 and capable of driving the photosensitive drum 208. FIG. 16 also illustrates a motor 233 which is a driving source, a metal plate 234 which supports the motor 233 and the drum shaft 231, and a motor pinion 235 which meshes with the helical gear 232. The helical gear 232 is a gear of the present invention. In FIG. 16, an inner web and an outer web of the helical gear 232 are not illustrated because they are located at positions where they are not seen in FIG. 16.

As illustrated in FIG. 16, when the motor 233 serving as a driving source rotates, the motor pinion 235 into which the leading end of the motor shaft is press-fitted (or which is formed integrally with the motor shaft) rotates, rotating the helical gear 232. When the helical gear 232 rotates, the photosensitive drum 208 is rotated at a predetermined number of rotations.

In recent years, since laser beam printers are required to achieve both of improved quality of image and increased process speed (printing speed), they have a driving motor with a large number of rotations. However, the increased number of rotations of the driving motor causes vibration and noise, possibly causing displeasure of a user when the printer is used on a table.

However, if the gear of the present invention is applied to the printer, the vibration and the noise can be suppressed to a minimum level, and a comfortable office environment can be provided.

In the above description, the gear of the present invention is applied to the helical gear 232 that transmits a driving force to the photosensitive drum 208. However, another gear of the present invention may be applied to a process unit which exerts an effect on the photosensitive drum 208, or may be used as a gear which transmits a driving force to a sheet feeding mechanism used to convey a paper sheet.

### EXAMPLES

### Example 1

A concrete example of the first embodiment will be described as an example 1, and compared with comparative examples made by using conventional methods.

The example 1 is the composite gear illustrated in FIGS. 1A to 1C and FIG. 2. The first member 50 is made of a polybutadien terephthalate resin (with a glass fiber content of 30%), and the second member 30 is made of a polyacetal resin (copolymer). In specifications of the gear, a module m is 0.5, a pressure angle is 20°, the number of teeth is 91, a helix angle β is 20°, and a tooth width t is 10 mm. In addition, by using the mold and the manufacturing processes illustrated in FIGS. 3 to 5, the first member 50 was first formed, and then the second member 30 was formed.

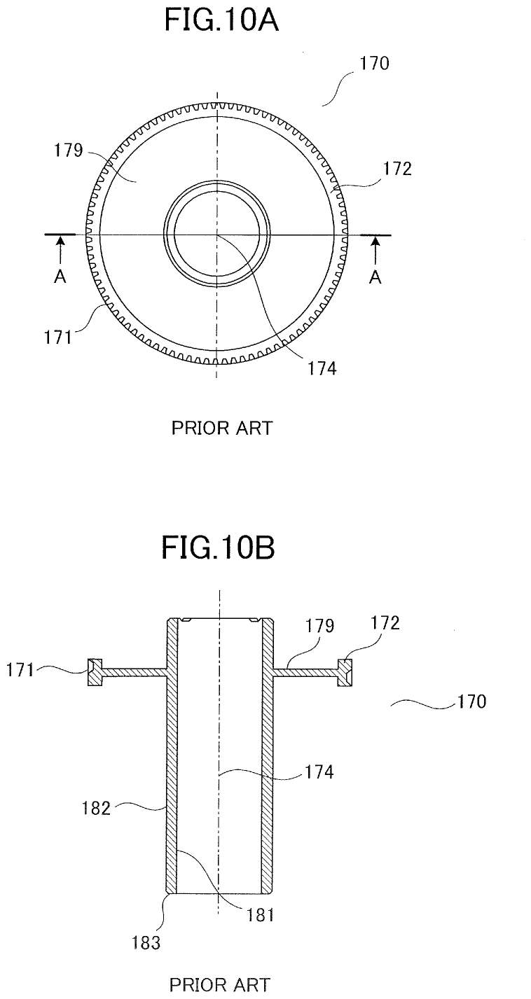

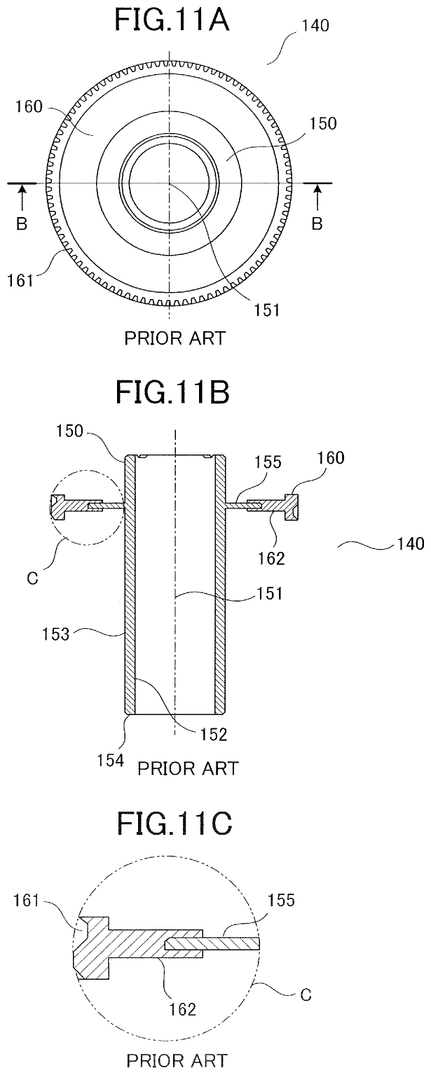

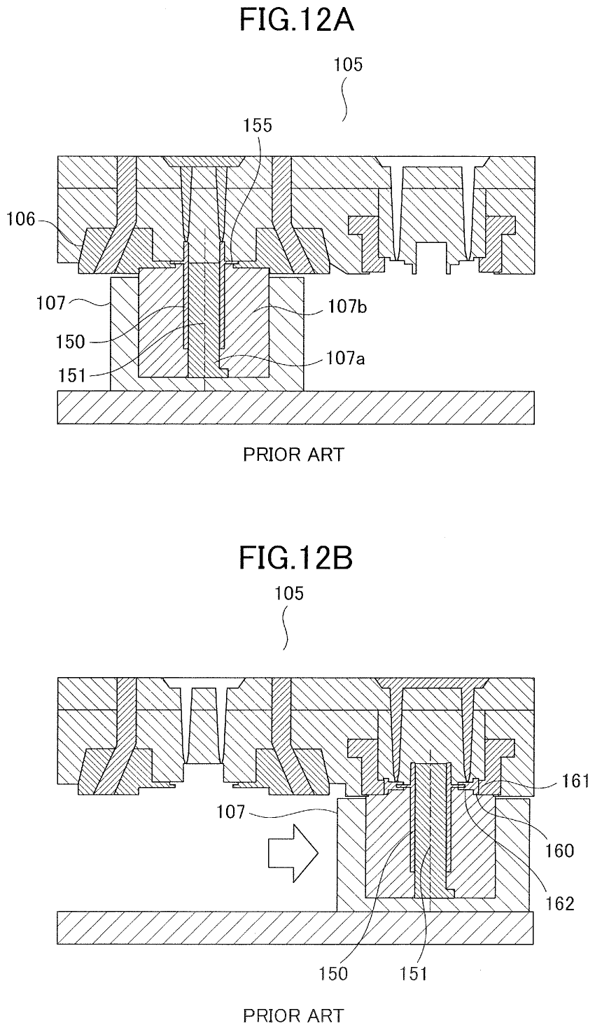

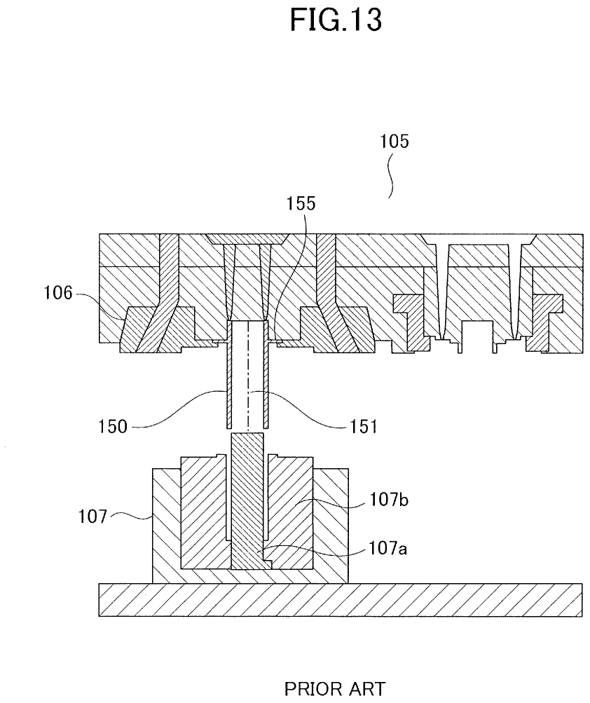

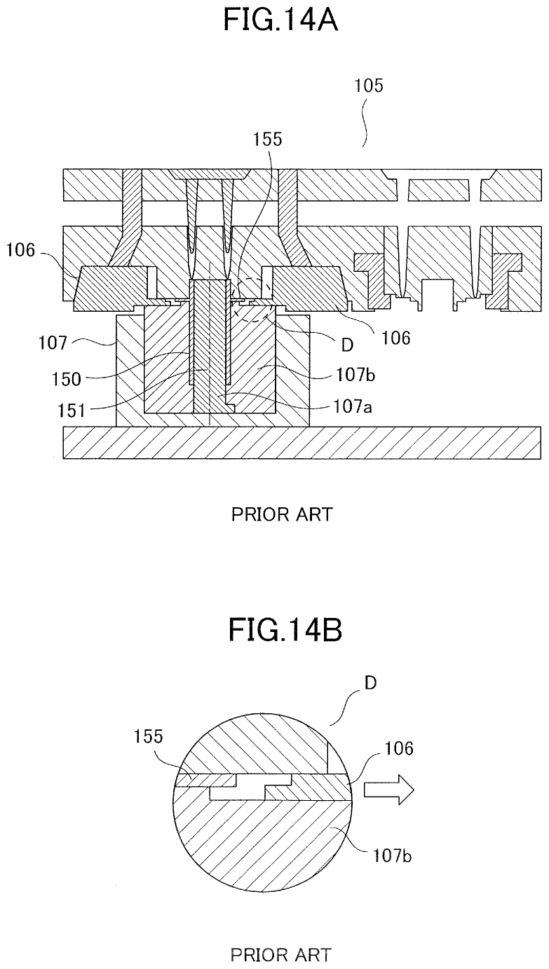

A comparative example 1 is a conventional resin gear as illustrated in FIGS. 10A and 10B, and is made of polyacetal (POM) resin alone. A comparative example 2 has the same shape as that of the comparative example 1, but is made of a polybutadien terephthalate (PBT) resin alone. A comparative example 3 is a composite gear as illustrated in FIGS. 11A to 11C. In the comparative example 3, the first member is made of the same material as that of the first member of the example 1, and the second member is made of the same material as that of the second member of the example 1. However, the outer web of the second member of the comparative example 3 is not sloped.

On the example 1 and the comparative examples 1 to 3, total meshing error measurement and rotation-transmission error measurement were performed. In the latter measurement, a transmission error caused by one tooth was measured when the gear was rotated at a torque of 6.0 Nm, and at a rotational speed of 25 rpm. In addition, abrasion of the mold was examined after 1,000 pieces of gear were made.

Table 1 illustrates the results.

TABLE 1

| | COMPARISON | COMPARISON | COMPARISON | |
|---|---|---|---|---|
| | EXAMPLE 1 | EXAMPLE 2 | EXAMPLE 3 | EXAMPLE 1 |
| MATERIAL | POM | PBT | PBT + POM | PBT + POM |
| WEB | NOT SLOPED | NOT SLOPED | NOT SLOPED | SLOPED |
| MOLD STATE | NOT ABRADED | NOT ABRADED | ABRADED | NOT ABRADED |
| (AFTER 1000 PIECES OF | | | | |
| GEAR WERE MOLDED) | | | | |
| TOTAL MESHING ERROR (μm) | 25.2 | 45.5 | 30.3 | 28.4 |
| ROTATION-TRANSMISSION | 3.5 | 2 | 0.4 | 0.5 |
| ERROR (μm) * | | | | |

* The rotation-transmission error is a transmission error caused by one tooth and measured when the gear was rotated at a torque of 6.0 N × m and at a rotational speed of 25 rpm.

In comparison between the example 1 and the comparative example 1, the rotation-transmission error of the comparative example 1 is significantly larger than that of the example 1. This is probably because the gear was deformed by the torque produced when the gear was rotated, because the rotation support portion and the tooth portion of the comparative example 1 are both made of the same material, polyacetal, having relatively low stiffness. Regarding the total meshing error, although the comparative example 1 has a slightly smaller value than that of the example 1, the difference is not significant.

In comparison between the example 1 and the comparative example 2, the total meshing error of the comparative example 2 is significantly larger than that of the example 1. This is probably because the gear of the comparative example 2, all of which is made of the polybutadien terephthalate resin which contains glass fiber, has affected by the fiber orientation than the gear made of the polyacetal resin, and the fiber orientation deteriorated the accuracy.

In comparison between the example 1 and the comparative example 3, there is no significant difference in the total meshing error and the rotation-transmission error. However, when the mold was examined after 1,000 pieces of gear were made, the mold used for the comparative example 3 was abraded, whereas the abrasion of the mold used for the example 1 was not detected. This is probably because the inner web of the first member of the comparative example 3 was formed by using the slide piece which was not sloped, and the slide piece was abraded during the slide performed before and after each molding. In contrast, in the example 1 of the present invention, the abrasion of the slide piece was reduced because the slide piece was sloped.

### Example 2

A concrete example of the second embodiment will be described as an example 2, and compared with comparative examples made by using conventional methods.

Materials and specifications of the example 2 are the same as those of the example 1. However, as illustrated in FIGS. 6A to 6C and FIG. 7, the bottom surface of the outer web of the second member of the example 2 is sloped like a mortar, so that the thickness of the outer web is constant in the circumferential direction.

On the example 2 and the comparative examples 1 and 3, the total meshing error measurement and the rotation-transmission error measurement were performed. In the latter measurement, a transmission error caused by one tooth was measured when the gear was rotated at a torque of 6.0 Nm, and at a rotational speed of 25 rpm. In addition, abrasion of the mold was examined after 1,000 pieces of gear were made.

Table 2 illustrates the results.

TABLE 2

| | COMPARISON | COMPARISON | |
|---|---|---|---|
| | EXAMPLE 1 | EXAMPLE 3 | EXAMPLE 2 |
| MATERIAL | POM | PBT + POM | PBT + POM |
| WEB | NOT SLOPED | NOT SLOPED | SLOPED |
| MOLD STATE | NOT ABRADED | ABRADED | NOT ABRADED |
| (AFTER 1000 PIECES OF | | | |
| GEAR WERE MOLDED) | | | |
| TOTAL MESHING ERROR (μm) | 25.2 | 30.3 | 25 |
| ROTATION-TRANSMISSION | 3.5 | 0.4 | 0.4 |
| ERROR (μm) * | | | |

* The rotation-transmission error is a transmission error caused by one tooth and measured when the gear was rotated at a torque of 6.0 N × m and at a rotational speed of 25 rpm.

In comparison between the example 2 and the comparative examples 1 and 3, the total meshing error of the example 2 is almost the same as that of the comparative example 1, and is smaller than that of the comparative example 3. Although the total meshing error of the example 1 is slightly larger than that of the comparative example 1, the total meshing error of the example 2 is decreased because the outer web of the second member of the example 2 is formed like a mortar and the uneven thickness of the outer web in the circumferential direction is reduced. In addition, the rotation-transmission error of the example 2 is smaller than that of the comparative example 1, and the abrasion of the mold used for the example 2 was significantly reduced compared to the comparative example 3.

### Example 3

A concrete example of the third embodiment will be described as an example 3, and compared with comparative examples made by using conventional methods.

Materials, specifications, and the sloped outer web of the example 3 are the same as those of the example 1. However, as illustrated in FIGS. 8A to 8C, the example 3 is provided with the groove in a position where the tooth portion and the outer web meet with each other so that the thickness of the outer web becomes constant in the whole circumference of the outer web.

On the example 3 and the comparative examples 1 and 3, the total meshing error measurement and the rotation-transmission error measurement were performed. In the latter measurement, a transmission error caused by one tooth was measured when the gear was rotated at a torque of 6.0 Nm, and at a rotational speed of 25 rpm. In addition, abrasion of the mold was examined after 1,000 pieces of gear were made.

Table 3 illustrates the results.

TABLE 3

| | COMPARISON | COMPARISON | |
|---|---|---|---|
| | EXAMPLE 1 | EXAMPLE 3 | EXAMPLE 3 |
| MATERIAL | POM | PBT + POM | PBT + POM |
| WEB | NOT SLOPED | NOT SLOPED | SLOPED |
| MOLD STATE | NOT ABRADED | ABRADED | NOT ABRADED |
| (AFTER 1000 PIECES OF | | | |
| GEAR WERE MOLDED) | | | |
| TOTAL MESHING ERROR (μm) | 25.2 | 30.3 | 24 |
| ROTATION-TRANSMISSION | 3.5 | 0.4 | 0.4 |
| ERROR (μm) * | | | |

* The rotation-transmission error is a transmission error caused by one tooth and measured when the gear was rotated at a torque of 6.0 N × m and at a rotational speed of 25 rpm.

In comparison between the example 3 and the comparative examples 1 and 3, the total meshing error of the example 3 is almost the same as that of the comparative example 1, and is smaller than that of the comparative example 3. In addition, the total meshing error of the example 3 is slightly smaller than those of the examples 1 and 2. This is probably because the groove is formed in the outer web in a position where the tooth portion and the outer web meet with each other so that the thickness of the outer web becomes constant in the whole circumference of the outer web. Here, even when the outer web has a plurality of slopes, as illustrated in FIG. 2, which cause the thickness of the outer web to change in the circumferential direction, the thickness of the outer web is constant in the vicinity of the tooth portion. Thus, the accuracy of shape of the tooth portion hardly changes in the circumferential direction, which allows the gear to have high accuracy. In addition, even if the sloped outer web has a thickness larger in the vicinity of the tooth portion, the adverse effect by the thickness can be reduced by the groove.

### Example 4

A concrete example of the fourth embodiment will be described as an example 4, and compared with comparative examples made by using conventional methods. Materials, specifications, and the shape of the outer web of the example 4 are the same as those of the example 1. However, as illustrated in FIGS. 9A to 9C, the gate used to form the second member was positioned, to form the gear, at or near a position where the outer web has its minimum thickness.

On the example 4 and the comparative examples 1 and 3, the total meshing error measurement and the rotation-transmission error measurement were performed. In the latter measurement, a transmission error caused by one tooth was measured when the gear was rotated at a torque of 6.0 Nm, and at a rotational speed of 25 rpm. In addition, abrasion of the mold was examined after 1,000 pieces of gear were made.

Table 4 illustrates the results.

TABLE 4

| | COMPARISON | COMPARISON | |
|---|---|---|---|
| | EXAMPLE 1 | EXAMPLE 3 | EXAMPLE 4 |
| MATERIAL | POM | PBT + POM | PBT + POM |
| WEB | NOT SLOPED | NOT SLOPED | SLOPED |
| MOLD STATE | NOT ABRADED | ABRADED | NOT ABRADED |
| (AFTER 1000 PIECES OF | | | |
| GEAR WERE MOLDED) | | | |
| TOTAL MESHING ERROR (μm) | 25.2 | 30.3 | 24.5 |
| ROTATION-TRANSMISSION | 3.5 | 0.4 | 0.4 |
| ERROR (μm) * | | | |

* The rotation-transmission error is a transmission error caused by one tooth and measured when the gear was rotated at a torque of 6.0 N × m and at a rotational speed of 25 rpm.

The rotation-transmission error is a transmission error caused by one tooth and measured when the gear was rotated at a torque of 6.0 N·m and at a rotational speed of 25 rpm.

In comparison between the example 4 and the comparative examples 1 and 3, the total meshing error of the example 4 is almost the same as that of the comparative example 1, and is smaller than that of the comparative example 3. In addition, the total meshing error of the example 4 is slightly smaller than those of the examples 1 to 3. This is because, as illustrated in FIGS. 9A to 9C, the gate used to form the second member of the example 4 was positioned at a position where the outer web has its small thickness, and thereby the resin was facilitated to flow toward a portion of the cavity corresponding to a thick portion of the outer web, improving filling performance.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-090875, filed May 9, 2018, which is hereby incorporated by reference herein in its entirety.

What is claimed is:

1. A method of manufacturing a gear by using a fixed mold and a moving mold which are configured to form a cavity used to injection-mold a center portion of the gear and a cavity used to injection-mold a peripheral portion of the gear, the fixed mold comprising a plurality of slide pieces configured to form one portion of an inner web of the gear, the moving mold comprising a forming surface configured to form one portion of an outer web of the gear, the method comprising:
causing a bottom surface of each of the plurality of slide pieces and the forming surface to abut against each other to form the cavity used to form the center portion, wherein the bottom surface of each slide piece is sloped with respect to a slide direction of the slide piece, and the forming surface is sloped with respect to the slide direction,
injecting a first material from a first gate to the cavity to form the center portion,
sliding each of the plurality of slide pieces along the slide direction of each of the plurality of slide pieces to separate the bottom surface of each of the plurality of slide pieces from the forming surface,
moving the moving mold, holding the center portion, to a position where the moving mold forms the cavity used to form the peripheral portion with the fixed mold, and
injecting a second material from a second gate to the cavity to form the peripheral portion, the second material being different from the first material.

2. The method according to claim 1, wherein the forming surface comprises a sloped portion whose contour lines are concentric circles.

3. The method according to claim 1, wherein the forming surface comprises a plurality of flat portions whose sloping directions are different from each other.

4. The method according to claim 1, wherein the cavity used to form the peripheral portion is a cavity to form an annular groove in the peripheral portion, between the outer web and a rim of the gear.

5. The method according to claim 1, wherein the second gate is disposed at a position that corresponds to the outer web to be formed.

6. A gear comprising:
a center portion comprising a rotation support portion and an inner web; and
a peripheral portion comprising an annular rim having teeth and an outer web, and made of a material different from a material of the center portion;
wherein one portion of the outer web is configured to hold one portion of the inner web, and
wherein an outer surface of the one portion of the outer web is sloped such that a thickness of the outer web increases as the outer web extends from the rotation support portion toward the rim.

7. The gear according to claim 6, wherein the outer surface of the one portion of the outer web is sloped such that contour lines of the outer surface are circles formed around a rotation axis of the gear.

8. The gear according to claim 6, wherein the outer surface of the one portion of the outer web comprises a plurality of flat surfaces sloped such that the thickness of the outer web increases as the outer web extends from the rotation support portion toward the rim.

9. The gear according to claim 6, wherein an annular groove is formed in the peripheral portion, between the one portion of the outer web and the rim.

10. The gear according to claim 6, wherein a gate mark is formed on the one portion of the outer web, and
wherein the gate mark is formed when the peripheral portion is injection-molded.

11. An image forming apparatus comprising:
the gear according to claim 6, and
a photosensitive drum on which an electrostatic latent image is to be formed.

12. The image forming apparatus according to claim 11, wherein a driving mechanism that rotates the photosensitive drum comprises the gear.
